(19) United States
(12) Patent Application Publication
(10) Pub. No.: US 2021/0151994 A1
(43) Pub. Date: May 20, 2021

(54) METHOD FOR CHARGING BATTERIES FOR AN AIRCRAFT AND SYSTEM FOR STORING ELECTRICAL ENERGY

(71) Applicant: ZODIAC AERO ELECTRIC, Montreuil (FR)

(72) Inventors: Anthony Kremer, Montreuil (FR); Guillaume Cherouvrier, Montreuil (FR)

(21) Appl. No.: 16/622,803

(22) PCT Filed: Jun. 7, 2018
(86) PCT No.: PCT/EP2018/064978

§ 371 Date: Dec. 13, 2019

(30) Foreign Application Priority Data
Jun. 14, 2017 (FR) 1755362

(51) Int. Cl. H02J 7/00; H01M 10/44

(52) U.S. Cl. CPC H02J 7/0014; H01M 2220/20; H01M 10/441; H02J 7/00036

(57) ABSTRACT

The present disclosure provides methods for charging batteries and systems configured to store electrical energy, the systems including batteries charged by the inventive methods.

The invention relates to a battery charging method for an aircraft and an electrical energy storage system for an aircraft comprising a set of batteries.

A battery is generally formed by one or more cells capable of storing and of delivering an electrical energy.

It is known practice to charge several batteries in series. However, this type of configuration generally has batteries whose open-circuit voltage between the most charged cell belonging to a battery and the least charged cell requires an equalization of all the cells, including on the cells of the other batteries.

Furthermore, depending on the number of batteries in series to be charged and on the open-circuit voltage requested, it is sometimes necessary to have a specific charger for each open-circuit voltage level desired. That significantly increases the development costs.

Another configuration has been proposed in which the batteries are linked in parallel to one another.

For this type of configuration, it is known practice to first of all perform the connecting of the batteries then to charge said batteries until one battery or a cell of the battery is charged.

However, the charging of said batteries is not controlled individually and independently. The batteries may therefore not be charged to their maximum level when the charging of the set of the batteries is interrupted following the complete charging of a single cell of a charged battery.

It may on the contrary be that charging is continued, leading to overcharges for the cells of one or more of the most charged batteries. That leads to definitive degradations of said cells and safety problems.

There is therefore a need to provide a battery charging method for an aircraft that is effective and that does not present the abovementioned drawbacks.

According to a first aspect, the subject of the invention is a battery charging method for an aircraft comprising the steps in which:

step A—a set of parallel-connected batteries is positioned, each battery having a specific maximum charge voltage, said set being linked to a single battery charger;

step B—a first battery is connected to the battery charger, said battery having the lowest open-circuit voltage of the open-circuit voltages of the set of the batteries;

step C—a current setpoint is sent into the first battery so as to increase the open-circuit voltage of the battery until it is substantially equal to the open-circuit voltage of a second battery which is the lowest open-circuit voltage of the open-circuit voltages of the set of the batteries;

step D—the second battery is connected to the charger;

step E—a second current setpoint is sent into the first and second batteries so as to increase the open-circuit voltage of said batteries until it is substantially equal to the open-circuit voltage of another battery which is the lowest open-circuit voltage of the open-circuit voltages of the set of the batteries;

step F—the steps D and E are repeated until each battery has reached the maximum charge voltage specific to said battery;

step G—each battery whose new voltage is higher than the specific maximum voltage of said battery is disconnected from the charger.

By virtue of the invention, all the cells of the set of batteries are charged with a single charger which reduces the costs. Indeed, it is possible to use a standard charger.

Furthermore, since the cells of each battery are charged battery by battery, the protection level corresponds to that of a single battery charge. The charging safety for the set of the batteries is therefore conserved.

Furthermore, the charge time for the set of the batteries is close to that of a single battery since the cells of each battery are charged from the lowest open-circuit voltage of the open-circuit voltages to the highest specific open-circuit voltage of the open-circuit voltages.

The invention also allows for a time saving while limiting the current peaks upon the initial connection in the event of connection of two batteries having different open-circuit voltages. Generally, the management of the current in each battery is better controlled.

The fact that there is only a single charger also makes it possible to limit the number of connections on each battery, which results in battery cost and weight savings.

According to particular embodiments of the invention, the method of the invention can comprise one or more of the following features taken in isolation or according to all possible combinations:
prior to or during the step A, the open-circuit voltage of each of the batteries is determined;
the open-circuit voltages of the set of the batteries are identical;
the set of batteries comprises batteries that are identical or different;
a communication element is capable of making the communication interface between the set of batteries and the charger;
the communication element is an electronic circuit board belonging to a battery or being external to the set of batteries;
the connecting and the disconnecting of each battery are performed using a switch dedicated to said battery;
during the step C, the current setpoint is a constant value for a predefined time interval or an increasing value for a first time interval then constant for a second time interval;
the step G is performed at the end of step E.

Another subject of the invention is an electrical energy storage system for an aircraft comprising a set of parallel-connected batteries, each comprising a plurality of cells and being associated with a specific switch, a charger connected to each of the batteries via said switch and a communication element for ensuring the communication between the batteries and the charger, said cells of said batteries being charged by the charging method according to the invention.

Other aims, features and advantages of the invention will become apparent on reading the following description, given purely as a nonlimiting example and with reference to the attached drawings in which:

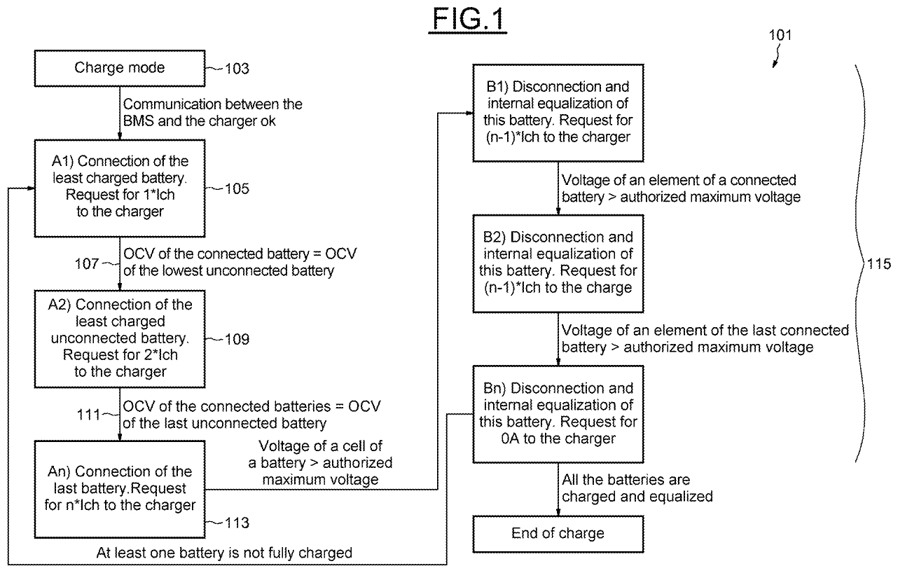

FIG. 1 is a diagram of an embodiment of the method according to the invention;

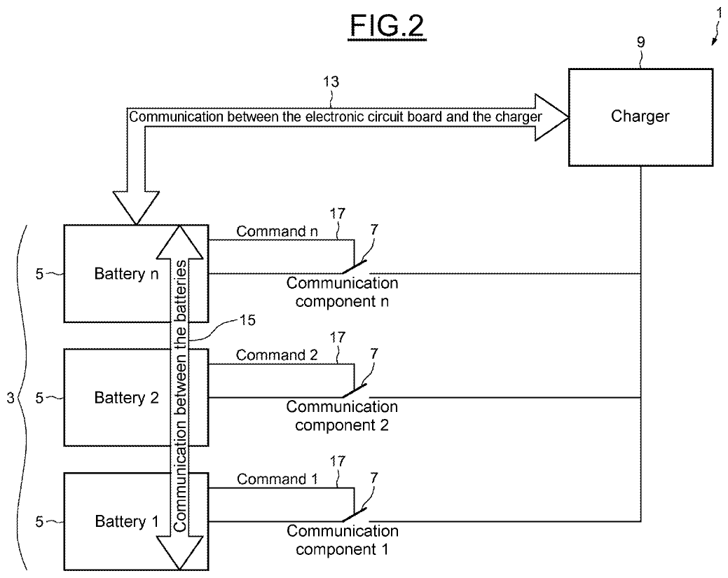

FIG. 2 is a diagram of a first embodiment of a storage assembly according to the invention in which the batteries are initially configured for a parallel charge;

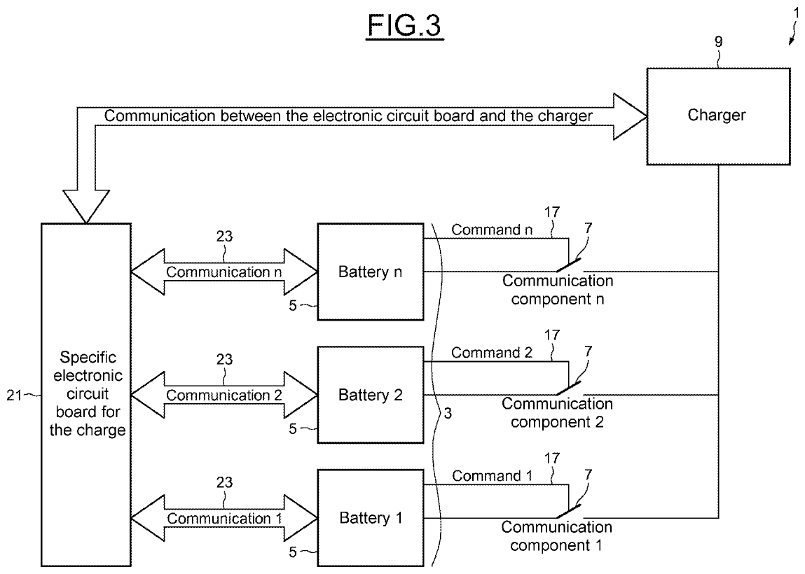

FIG. 3 is a diagram of a second embodiment of a storage assembly according to the invention in which the batteries, of li-ion type, are not initially configured for a parallel charge;

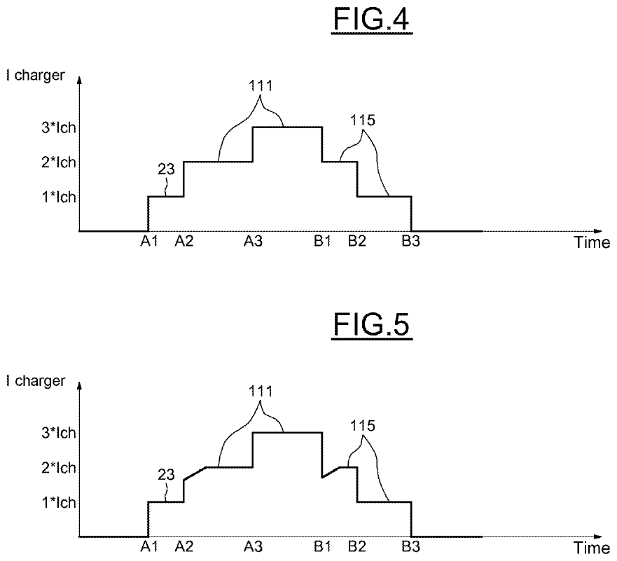

FIG. 4 is a schematic diagram of a first example of profile of the current setpoint employed in the method of the invention;

FIG. 5 is a schematic diagram of a second example of profile of the current setpoint employed in the method of the invention.

The electrical energy storage system of the invention makes it possible to store electrical energy to supply power to loads in an aircraft.

As illustrated in the figures, the system of the invention 1 comprises a set of parallel-connected batteries 3, each 5 being associated with a specific switch 7, a charger 9 connected to each of the batteries 5 via said switch 7 and a communication element for ensuring the communication between the batteries 5 and the charger 9, said batteries 5 comprising one or more cells charged by the charging method according to the invention which is detailed hereinbelow in the description.

The set of the batteries 3 can advantageously comprise batteries 5 having cells that are identical or different, namely cells of identical or different nature and/or identical or different numbers of cells.

The charger 9 can be a standard CHAdeMO protocol charger. Said protocol comprises an analog and CAN communication and a dedicated operating sequencing.

The communication element is capable of making the communication interface between the set of batteries 3 and the charger 9. Said communication element thus makes it possible to recover all the information from the batteries 5, in particular from the cells belonging to each battery, that is useful to the charger 9 to give overall information, even a request, to said charger 9.

To this end, the communication element can be an electronic circuit board belonging to a battery (see FIG. 2). In this case, the charger 9 communicates, as indicated by the arrow 13, with a single battery 5 of the set of batteries. Said single battery and the other batteries are also capable of communicating with one another, as indicated by the arrow 15, to exchange the state-of-charge data of each battery with the charger 9, in particular the level of the open-circuit voltage value.

According to a variant, the communication element can be an electronic circuit board 21 external to the set of batteries 3. This is particularly advantageous in the case where no battery employed is capable of communicating directly with the other batteries, in particular for the batteries not designed for a parallel charge. The electronic circuit board 21 and each battery 5 can be linked by a communication cabling such as a communication bus, or else, if the battery is not equipped with a communication bus, a set of analog voltages and a control of the switching component 7.

In this case, said board 21 is capable of communicating, as indicated by the arrow 23, with each of the batteries 5 to give the state-of-charge data of each battery 5 to the charger 9, in particular the data linked to the open-circuit voltage level.

The connecting and the disconnecting of each battery 5 to and from the charger 9 can be performed using a specific switch 7. Examples of switch 7 that can be cited include contactors, Solid State Power Controllers, called “SSPC”, or relays.

Each battery 5 can also advantageously comprise a control 17 so as to connect or disconnect the switch 7.

The control 17 can be in the form of an algorithm which allows the charge of the set 3 of the batteries to be optimized by connecting or by isolating each battery 5 with respect to the charger 9. Data can thus be communicated with the charger 9 in real time, like the charge current value.

Each battery can be capable of managing its own protections thus allowing for a logical operation saving. If one of the batteries exhibits an anomaly, it is possible for said battery to disconnect itself and therefore not prevent the other batteries from finishing their charge cycle.

The method of the invention 101 is a method for charging the batteries of the system of the invention comprising the steps in which: step A 103—a set of parallel-connected batteries 3 is positioned, each battery 5 having a specific maximum charge voltage, said set 3 being linked to a single battery charger 9;

step B 105—a first battery 5 is connected to the battery charger 9, said battery 5 having the lowest open-circuit voltage of the open-circuit voltages of the set of the batteries 3;

step C 107—a current setpoint is sent into the first battery 5 so as to increase the open-circuit voltage of the battery 5 until it is substantially equal to the open-circuit voltage of a second battery 5 which is the lowest open-circuit voltage of the open-circuit voltages of the set of the batteries 3;

step D 109—the second battery 5 is connected to the charger 9;

step E 111—a second current setpoint is sent into the first and second batteries 5 so as to increase the open-circuit voltage of the batteries 5 until it is substantially equal to the open-circuit voltage of another battery 5 which is the lowest open-circuit voltage of the open-circuit voltages of the set of the batteries;

step F 113—the steps D and E are repeated until each battery has reached the maximum voltage specific to said battery;

step G 115—each battery 5 whose new voltage is higher than the specific maximum voltage of said battery is disconnected from the charger 9.

The open-circuit voltage of each battery corresponds to the voltage of the cells if no current constraint lasting a long time is applied.

According to one embodiment, the specific open-circuit voltages of the set of the batteries 3 are identical. Thus, it is possible to use batteries of different nature but of identical specific open-circuit voltage.

During the step A 103, a set of parallel-connected batteries 3 is positioned, each battery 5 having a specific maximum charge voltage, said set 3 being linked to a single battery charger 9.

Preferably, prior to or during the step A 103, the open-circuit voltage of each of the batteries 5 can be determined in order to estimate the level of charge of the cells and thus determine whether a battery 5 is charged. It is also possible to determine the order of the batteries 5 to be connected to the charger 9 as a function of the open-circuit voltage value. This determination can be made by using a BMS, or “Battery Management System”.

During the step B 105, a first battery 5 is connected to the battery charger 9, said battery 5 having the lowest open-circuit voltage of the open-circuit voltages of the set of the batteries 3.

Said first battery 5 can be in communication with said charger 9 in order to follow the trend of the open-circuit voltage.

During the step C 107, a current setpoint is sent into the first battery 5 so as to increase the open-circuit voltage of the battery 5 until it is substantially equal to the open-circuit voltage of a second battery 5 which is the lowest open-circuit voltage of the open-circuit voltages of the set of the batteries 9.

Thus, the first and second batteries 5 have substantially the same open-circuit voltage which has become the lowest open-circuit voltage of the open-circuit voltage determined prior to or during the step A 103. By virtue of the communication element, the charger 9 is informed of the new open-circuit voltage value of the first battery 5.

According to an embodiment represented in FIG. 4, during the step C 107, the current setpoint has a constant value for a predefined time interval.

As an example, the current setpoint can be a current at most substantially equal to 100% of the capacity of the battery or 1 C per connected battery, for a maximum time substantially equal to 1 h.

According to a variant represented in FIG. 5, the value of the current setpoint can increase during a first time interval then be constant during a second time interval.

Thus, the current setpoint can be a current starting from a value substantially equal to 80% of the capacity of the battery or 0.8 C per connected battery and arriving at a value substantially equal to 100% of the capacity of the battery or 1 C per connected battery for a first time substantially equal to a few minutes then be a current substantially equal to the capacity of the battery or 1 C per connected battery for a time substantially equal to 1 h.

During the step D 109, the second battery 5 is connected to the charger 9. To do this, the switch 7 specific to the second battery 5 can be closed. Thus, the first and second batteries 5 connected to the charger 9 have a substantially identical open-circuit voltage.

During the step E 111, a second current setpoint is sent into the first and second batteries 5 so as to increase the open-circuit voltage of the batteries 5 until it is substantially equal to the open-circuit voltage of another battery 5 which is the lowest open-circuit voltage of the open-circuit voltages of the set of the batteries.

Thus, at the end of the step E 111, the first and second batteries 5 have substantially the same open-circuit voltage as the other battery 5 which has become the lowest open-circuit voltage of the open-circuit voltages determined prior to or during the step A 103. This information can be given to the charger 9 via the communication element.

As previously, the current setpoint sent during the step E 111 is a constant value for a predefined time interval (FIG. 4) or increases during a first time interval then is constant for a second time interval (FIG. 5). This latter setpoint profile is particularly advantageous when the internal resistances of the batteries 5 are unbalanced. The ramp is thus chosen so as to send a current setpoint slightly lower than the final maximum current setpoint which will remain constant for a predefined time interval.

The current setpoint can be predetermined or adapted according to the number of batteries 5 connected to said charger 9 and according to the number of cycles done during the complete charge of said battery or batteries 5.

During the step F 113, the steps D 109 and E 111 are recommenced until each battery 5 reaches the specific maximum voltage.

During the step G 115, each battery 5 of which at least one cell has reached its specific maximum voltage is disconnected from the charger 9. Thus, advantageously, there is an assurance that the cells of each battery are charged to an open-circuit voltage which remains lower than or equal to the voltage that can be accepted by the cells without damaging the latter.

The open-circuit voltage is employed for the first connection of each battery. Subsequently, the voltage used is a directly measured voltage.

The disconnecting can be done by opening the switch or switches 7 of said battery or batteries to be disconnected.

The disconnecting has the effect of allowing the equalization of each disconnected battery 5, in particular of the elements of that battery, such as each of the series branches of the batteries. The battery or batteries 5 are equalized independently. It is therefore advantageously possible to use an equalizing algorithm that is known or, on the contrary, specific to the use without having to modify the architecture of the system 1 of the invention or of the charger 9.

For this, the battery is left disconnected from the charge 9 with no charge current for said battery. The other batteries that have not commenced their equalization phase continue to be charged.

The step G can be performed at the end of the step E. In other words, the disconnecting of the battery or batteries 5 from the charger 9 can take place between the different current setpoint sending cycles or be performed at the end of the process of charging of the set 3 of batteries by simultaneously opening all the switches 7.

The invention thus makes it possible to:
sequentially manage the batteries and therefore limit the aging of each battery by a better distribution of the currents in each battery and an optimization of the charge time;
use only a single charger for the set of batteries, which can be a standard charger, in order to simultaneously recharge the batteries of the system of the invention, while keeping the same level of protection as for a single battery charge;
save time, manage the initial connection by limiting the current peaks in the batteries in the event of the connection of two batteries with different voltages, and the management of the current in each battery;
limit the number of connections, and therefore have cost and weight savings.

1. A method for charging batteries for an aircraft, comprising:
positioning a set of parallel-connected batteries, each battery having a specific maximum charge voltage, said set being linked to a single battery charger;
connecting a first battery to the battery charger, said first battery having a lowest open-circuit voltage of all open-circuit voltages of the set of the batteries;
sending a current setpoint having a value that increases for a first time interval and remains constant for a second time interval into the first battery so as to increase the open-circuit voltage of the first battery until the open-circuit voltage of the first battery is substantially equal to an open-circuit voltage of a second battery which is the lowest open-circuit voltage of the open-circuit voltages of the set of the batteries;
connecting the second battery to the charger;
sending a second current setpoint into the first and second batteries to increase the open-circuit voltages of said first and second batteries until the open-circuit voltages of the first and second batteries is substantially equal to an open-circuit voltage of another battery which is the lowest open-circuit voltage of the open-circuit voltages of the set of the batteries;
repeating said connecting the second battery and said sending a second current setpoint until each battery of the set has reached its specific maximum charge voltage; and
disconnecting each battery whose open-circuit voltage is higher than its specific maximum voltage from the charger.

2. The method of claim 1, wherein prior to or during said positioning a set of parallel-connected batteries, determining the open-circuit voltage of each of the batteries of the set.

3. The method of claim 2, wherein the open-circuit voltages of the batteries of the set determined prior to or during said positioning a set of parallel-connected batteries are identical.

4. The method of claim 1, wherein said positioning a set of parallel-connected batteries includes providing a communication element configured to make a communication interface between the set of batteries and the charger.

5. The method of claim 4, wherein the communication element is an electronic circuit board belonging to one battery of the set or being external to the set of batteries.

6. The method of claim 1, wherein the connecting and the disconnecting of each battery to and from the charger, respectively, is performed using a switch dedicated to said battery.

7. (canceled)

8. The method of claim 1, wherein said disconnecting each battery whose open-circuit voltage is higher than its specific maximum voltage is performed at an end of said sending a second current setpoint into the first and second batteries.

9. (canceled)

10. A method for charging aircraft batteries, comprising:
linking a set of parallel-connected batteries to a battery charger, each battery of the set having an open-circuit voltage and a specific maximum charge voltage;
electrically connecting a lowest-open-circuit-voltage battery of the set to the battery charger, the lowest-open-circuit-voltage battery having a lowest open-circuit voltage of all open-circuit voltages of the set of the batteries;
increasing the open-circuit voltage of the lowest-open-circuit-voltage battery until it is substantially equal to the open-circuit voltage of a next-lowest-open-circuit voltage battery of the set, by sending a current setpoint to the lowest-open-circuit-voltage battery, wherein the current setpoint increases for a first time interval and remains constant for a second time interval;
electrically connecting the next-lowest-open-circuit-voltage battery to the charger;
increasing the open-circuit voltages of the lowest-open-circuit-voltage battery and the next-lowest-open-circuit-voltage battery until they are substantially equal to the open-circuit voltage of a next-highest-open-circuit-voltage battery of the set, by sending a second current setpoint to the lowest-open-circuit-voltage battery and the next-lowest-open-circuit-voltage battery;
repeating the foregoing electrically connecting steps and increasing steps until each battery of the set reaches its specific maximum charge voltage; and
disconnecting, from the charger, each battery of the set having its open-circuit voltage higher than its specific maximum charge voltage.
